(19) United States
(12) Patent Application Publication
(10) Pub. No.: US 2007/0288419 A1
(43) Pub. Date: Dec. 13, 2007

(54) METHOD AND APPARATUS FOR AUGMENTING DATA AND ACTIONS WITH SEMANTIC INFORMATION TO FACILITATE THE AUTONOMIC OPERATIONS OF COMPONENTS AND SYSTEMS

(75) Inventor: John C. Strassner, North Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/422,661

(22) Filed: Jun. 7, 2006

(51) Int. Cl. G06F 17/00

(52) U.S. Cl. 706/55

(57) ABSTRACT

A system includes object construction logic [700] and semantic augmentation logic [705]. The object construction logic receives events and data. It also identifies whether managed objects exist in a predefined set of at least one information model [205] and at least one ontology [240] corresponding to the events and data. The object construction logic [700] further deduces, based on the events and data, whether any previously unknown managed objects exist corresponding to the events and data. The semantic augmentation logic [705] augments at least one of the managed objects and the previously unknown managed objects with semantic information based on knowledge-based reasoning and state awareness, according to at least one installed policy to generate at least one new object and provide the at least one new object to an autonomic processing engine.

### RELATED APPLICATIONS

“AUTONOMIC COMPUTING METHOD AND APPARATUS” as is filed concurrently with present application using attorney's docket number CML03322N;

“METHOD AND APPARATUS FOR HARMONIZING THE GATHERING OF DATA AND ISSUING OF COMMANDS IN AN AUTONOMIC COMPUTING SYSTEM USING MODEL-BASED TRANSLATION” as is filed concurrently with present application using attorney's docket number CML02977N; and

“PROBLEM SOLVING MECHANISM SELECTION FACILITATION APPARATUS AND METHOD” as is filed concurrently with present application using attorney's docket number CML03124N;

wherein the contents of each of these related applications are incorporated herein by this reference.

### TECHNICAL FIELD

This invention relates generally to fields of knowledge engineering, artificial intelligence, neural networks, information and data modeling, ontology engineering, and more particularly to the fields of self-managing (i.e., autonomic) computing systems.

### BACKGROUND

Networks often consist of heterogeneous computing elements, each with their own distinct set of functions and approaches to providing commands and data regarding the operation of those functions. Furthermore, even the same product from the same vendor can run multiple versions of a device operating system. As a consequence, these computing elements may (and often do) have different, incompatible formats for providing data and receiving commands.

Currently, management elements are built in a custom/stovepipe fashion precisely because of the above limitations. This leads to solution robustness burdened by scalability problems. More importantly, it prohibits management systems from sharing and communicating decisions on similar data and commands. Hence, additional software must be built for each combination of management systems that need to communicate.

The result of the current state-of-the-art is a frequent inability to correlate different instances of events and data to understand their common semantics (e.g., a single common cause of multiple problems reported). For example, it is often impossible to directly correlate a Service Level Agreement (SLA) violation for a customer or set of customers with an alarm issued by a network device, since the network device has no understanding of “customer” or “SLA.” This dramatically increases the complexity of the overall system.

Current systems in the art do not offer any viable solutions for constructing a framework that can serve the needs of different architectural styles translating different data and commands in multiple languages into a single common language. Moreover, many current systems cannot dynamically incorporate new knowledge, nor can they use a combination of information and data modeling, ontology engineering, machine learning, and/or knowledge-based reasoning to build their knowledge base.

A current autonomic system in the art is organized into two major elements—a managed element and an autonomic manager—that are both governed by a single control loop. A managed element is what the autonomic manager is controlling. An autonomic manager is a component that governs the functionality provided by the managed element (implemented using a particular control loop). The managed element is controlled through its sensors and effectors. The sensors provide mechanisms to collect information about state and state transition of an element, and the effectors are mechanisms that change the state (configuration) of an element.

This system is deficient, however, because it does not differentiate between different types of inputs on its sensors and outputs from its effectors (e.g. differentiating between the concepts of data versus management and control information is required). This system also puts a translation burden on its sensors (to translate and format all applicable information) and the effectors (to also translate commands into a form that the managed resource can understand). This, in turn, adversely affects complexity and scalability of the solution. Another defect of this system is that it has no ability to harmonize different representations of the same data (e.g., for upgrading commands in a previous operating system release to a new version of the operating system). Moreover, this system cannot easily incorporate new data. In other words, when new data is given to a sensor, the sensor is limited to simply passing that data to the autonomic manager. This, however, places the burden on the autonomic manager to learn the definition, format limitations and restrictions, and meaning of the new data, which in turn leads to complexity and scalability problems.

This system further lacks an ability for its autonomic managers to observe characteristics of gathered data and change the type of data that should be retrieved. Moreover, the monitor portion of this system is completely passive. In other words, it cannot take action to change the objects and data that it is monitoring, or the correlation, filtering, and other strategies employed. This places a burden on the autonomic manager in that it must now perform these functions.

Current implementations of the sensors and effectors based on this architecture focus on using the Common Information Model (“CIM”) data model. The CIM model, however, lacks a number of features required for autonomics, including state, business objects, policy language, and so forth. The sensors and effectors of this system are also semantically overloaded, since both policies and either commands or data must flow over each. This system is further deficient in that it cannot learn or reason about received events and/or data.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a method of defining a new semantic data structure according to various embodiments of the invention;

FIG. 2 illustrates a distributed, but self-contained, subsystem according to various embodiments of the invention;

FIG. 3 illustrates an information system according to various embodiments of the invention;

FIG. 4 illustrates a conceptual block diagram of an autonomic framework according to various embodiments of the invention;

FIG. 5 illustrates an object construction process according to various embodiments of the invention;

FIG. 6 illustrates the semantic augmentation process according to various embodiments of the invention;

FIG. 7 illustrates the object construction and semantic augmentation logic according to various embodiments of the invention;

FIG. 8 illustrates an object represented in UML according to the prior art; and

FIG. 9 illustrates a semantically augmented object according to various embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION

Generally speaking, pursuant to these various embodiments, a method, apparatus, and system are provided that describe a set of mechanisms that augment events and data received from a managed resource with additional semantic knowledge from information and data models as well as from a set of ontologies. In essence, these teachings provide for the identification of managed objects from received events and/or data, as well as deducing the existence of previously unknown managed objects, and then augmenting these identified objects with additional semantic information to produce a new set of objects that contains the original data and applicable semantic data, both in object form. This new form is a new semantic object data structure that is more suitable for decision-making. For example, it enables a system to more quickly determine the relevance of a given event or data, as well as identify other managed elements that may be affected by the particular event or data received. It also includes facilities to dynamically incorporate new knowledge that can be used to augment future events and data.

Semantic data is information that is included in a received object and/or information deduced by the autonomic system being described that helps to describe the behavior of the object. The semantic data may include, e.g., an indication of the degree of degree of severity of a problem associated with the object. For example, the semantic data can be used to describe the severity of a router malfunction. Semantics enable various types of complexity to be managed. Ontologies represent different types of semantics efficiently, and can be used to augment the information represented by information and data models. So, through various mechanisms, a system can deduce that a customer is affected by an alarm, even though the received alarm has no customer information.

Complexity takes two fundamentally different forms—system and business complexity. Complexity arising from system and technology is spurred on in part by the inexorability of Moore's Law. This is one reason why programmers have been able to exploit increases in technology to build more functional software and more powerful systems. Functionality, however, comes at a price, and the price that has been paid is the increased complexity of system installation, maintenance, (re)configuration, and tuning. The trend is for this complexity to increase—not only are systems exceedingly complex now, but the components that build them are themselves complex stovepipes, consisting of different programming models and requiring different skill sets to manage them. Furthermore, systems will always become more complex, because everyone wants more for less.

The complexity of doing business is also increasing because end-users want simplicity. Ubiquitous computing, for example, motivates the move from a keyboard-based to a task-based model, enabling the user to perform a variety of tasks using multiple input devices in an “always connected” presence. This requires an increase in intelligence in the system, which is where autonomics comes in. Autonomics enables governance models to drive business operations and services. Autonomics helps by defining and enforcing a consistent governance model to simplify management.

Currently, too much time is being spent in building infrastructure. This is a direct result of people concentrating on technology problems instead of how business is conducted. There is a good reason for this. Concentrating on just the network, different devices have different programming models, even from the same vendor. For example, there are over 250 variations of Cisco IOS 12.0S. This simply represents the Service Provider feature set of IOS, and there are many other different features sets and releases that can be chosen. Worse, the Cisco 6500 Catalyst switch can be run in Internetwork Operating System (“IOS”), Catalyst Operating System (“CatOS”), or hybrid mode, meaning that multiple operating systems can be run at the same time in a single device. This means that there are multiple data representations and multiple commands available for the same device.

A common Service Provider environment is one in which the Command Line Interface (“CLI”) of a device is used to configure it, and Simple Network Management Protocol (“SNMP”) is used to monitor the performance of the device. But a problem arises when mapping between SNMP commands and CLI commands. There is no standard to do this, which implies that there is no easy way to prove that configuration changes made in CLI solve the problem. Since networks often consist of specialized equipment, each with their own language and programming models, the demand for these teachings is very strong.

These teachings provide a system in which the infrastructure can be taken care of automatically, enabling more time to be spent defining the business logic necessary to build a solution. Business logic is comprised of both commands and data. Sensors need to understand the data that they are monitoring, so if two devices use two different languages (such as CLI and SNMP), then a common language needs to be used to ensure that each device is being told the same thing. These teachings provide a semantic data structure optimized for knowledge engineering processes that is used by other components of the system.

A primary business imperative is to be able to adjust the services and resources provided by the network in accordance with changing business policies and objectives, user needs, and environmental conditions. In order to do this, the system needs a robust and extensible representation of the current state of the system, and how these three changes affect the state of the system.

The system also needs the ability to abstract the functionality of components in the system into a common form, so that the capabilities of a given component are known, and any constraints (business, technical and other) that are applied to that component are known. This enables the system to be, in effect, “reprogrammed” so that it can adjust to faults, degraded operations, and/or impaired operations. These teachings provide the semantic information required to determine the relationship and interaction between different resources and services.

In order for the above dynamic adjustment to avoid deadlock situations (e.g., of constantly trying to reconfigure elements that in turn cause conflicts with other elements), any and all configuration changes are managed as a closed control loop. These teachings accommodate provision of at least most of the required semantic information to form a closed control loop.

For the sake of simplicity, the examples provided below are directed to information models. It should be appreciated, however, that these teachings may also be implemented with data models in a way analogous to that described for information models. The difference between an information model and a data model is relatively straightforward. An information model is an abstraction and representation of the entities in a managed environment. This includes definition of their attributes, operations and relationships. It is independent of any specific type of repository, software usage, or access protocol. A data model, on the other hand, is a concrete implementation of an information model in terms appropriate to a specific type of repository that uses a specific access protocol or protocols. It includes data structures, operations, and rules that define how the data is stored, accessed and manipulated.

The difference between using an information model and a data model is that, in Directly Enabled Networks-new generation (“DEN-ng”), data models are derived from information models. Data models represent more specific objects, while information models represent more general objects. Thus, these teachings can use either information models (and therefore operate abstractly) and/or data models (and therefore operate with physical objects). These mechanisms are designed to work with other subsystems that are part of a larger computing system. By at least one approach these teachings function as a part of an autonomic computing system.

The term “autonomic computing” invites parallels to the biological connotation of the autonomic nervous system. Specifically, people do not typically think about pumping blood or regulating their sugar levels at every waking moment of their lives. This frees their brains to concentrate on other tasks. Similarly, autonomic computing frees managers and administrators from governing low-level, yet critical, tasks of a system so that business may proceed as planned without requiring highly trained specialists to watch the system and continually attempt to manually adjust its every operation. This does not imply that an autonomic system does not need humans to operate it. Instead, the purpose of an autonomic system is to simplify and manage the complexity of the environment so that skilled resources can be better leveraged.

One important point about autonomic computing, as described below, is that it typically refers to a “self-governing” system. This is in direct contrast to common definitions of autonomic computing in the art, which emphasize a “self-managing” system. These teachings use a “self-governing” system because most examples today of self-managing systems use a statically defined set of rules to govern their operation. The self-managing systems of today, however, encounter problems when the business changes its priorities, the needs of the user change, and/or environmental conditions change. A statically defined rule set cannot adapt to these and other changes. These and other changes in and to the managed environment necessitate a governance model, i.e., one in which changes are made in order to optimize the underlying business rules that control the services and resources being offered at any one time.

These teachings generally enable such underlying business rules to reflect changes in the needs of the organization, the needs of users that are using network services and resources, and to respond appropriately to environmental conditions. This requires a common definition of data gathered from the system and environment as well as commands issued to the system. It also requires policies and processes to change in accordance with these three types of changes.

It is the holistic combination of policy and process, under a governance model, that enables autonomic elements to reflect those changes in a structured manner. Hence, the autonomic system described herein is one in which each autonomic element has knowledge of itself and of its environment. For the purposes of the examples described below, “knowledge” comes in two distinct forms. Static knowledge refers to facts that the system has pre-loaded. Dynamic knowledge refers to the ability to reason about its stored facts, stored processes, and sensor inputs, and infer new facts.

There are several forms of knowledge that the system has. The most basic consist of facts that can be accessed as part of a rule-based or case-based reasoning process. An example of this is the reception of sensor data, i.e., received data and/or events are matched to predefined facts so that the received data and/or events can be identified. The next basic type of knowledge consists of the ability to learn about data.

The system includes sensors and effectors. A sensor is an entity, e.g. a software program that detects and/or transmits data and/or events from other system entities. An effector is an entity, e.g. another software program that performs some action based on the received data and/or events. For example, in the case of a router malfunction, the sensors may transmit data corresponding to the malfunction, and the effectors may receive corrective action (in the form of commands) to fix the malfunction.

An example of the ability to learn about data is that the reception of sensor data and/or events can be compared to a history of prior occurrences of data and/or events, and the system can determine the significance of the data and/or events. A third form of knowledge is the ability to use knowledge to reason about received data and/or events and draw its own conclusions as to the meaning and/or significance of the data and/or events received. For example, received data and/or events can be correlated with other facts and information already processed by the system to define a first approximation as to the significance of the received events and/or data. Another example is that the reception of data and/or events can itself be used by the system to direct the gathering of additional data and/or events in order to determine the significance of the data and/or events originally received.

The final form of knowledge is state. In other words, the system is aware of the set of states that an element (or aggregate of elements) may occupy and the internal and external forcing functions causing state transitions. This is a crucial capability of an autonomic system, i.e., if the system is to orchestrate the behavior of its constituent elements, then the system must have some representation of the different states that each of its constituent elements will pass through. The teachings presented below use the concept of finite state machines for this representation. This enables the system to define state transition frequencies and/or probabilities, additional pieces of knowledge that the system may draw upon in analysis activities. Drawing from the Directory Enabled Network-next generation (“DEN-ng”) paradigm (which itself is unique in the industry), it uses policy to control the occurrence of state transitions.

Self-knowledge enables self-governance because knowledge of the element, system, and its environment is required in order for governance to exist. The examples described below are crucial because they provide the foundation processes to managing heterogeneous devices through knowledge. These teachings define a new semantic data structure, derived from augmenting received events and/or data with both existing and deduced semantic information, contained in information models and ontologies. These teachings also enable new semantic information to be incorporated into the information models and ontologies.

These teachings also facilitate acceptance of events and/or data received from a monitored managed resource and identification of existing as well as new managed objects that exist in its predefined information models and ontologies. They then analyze these objects for additional semantics that can be added. Such additional semantic information is derived from a multiplicity of information models and/or ontologies. These teachings then define a new semantic data structure that can hold the integrated combination of the original events and/or data and the augmented semantic information, and are capable of adding newly discovered objects to the information and ontology models dynamically.

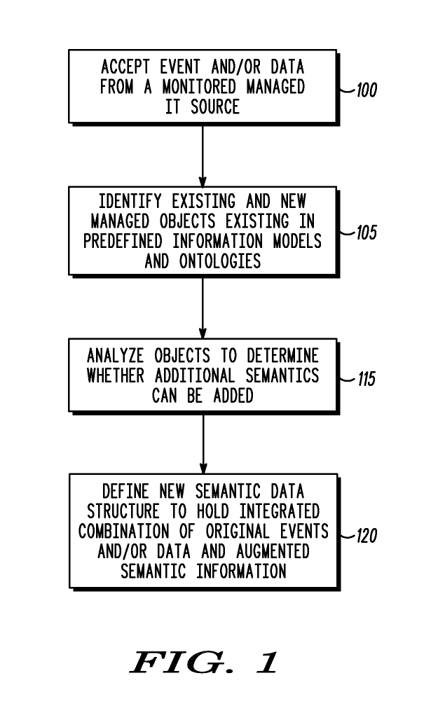

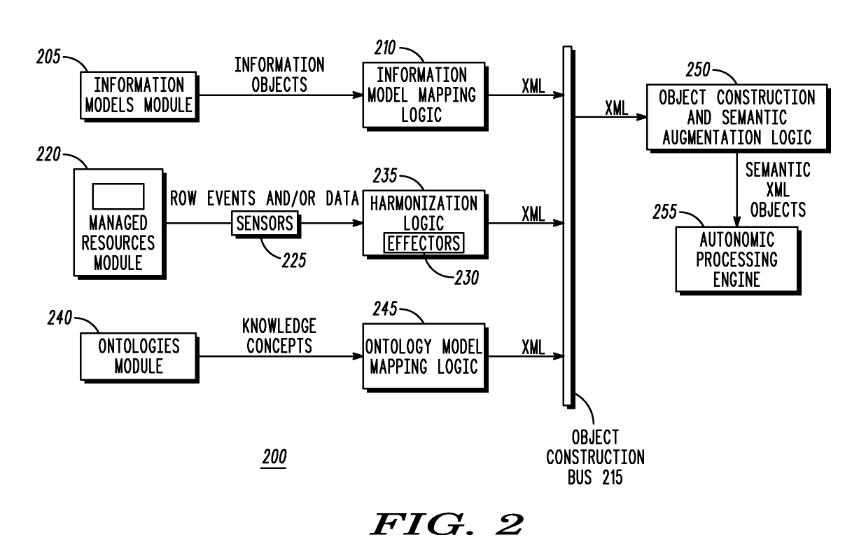

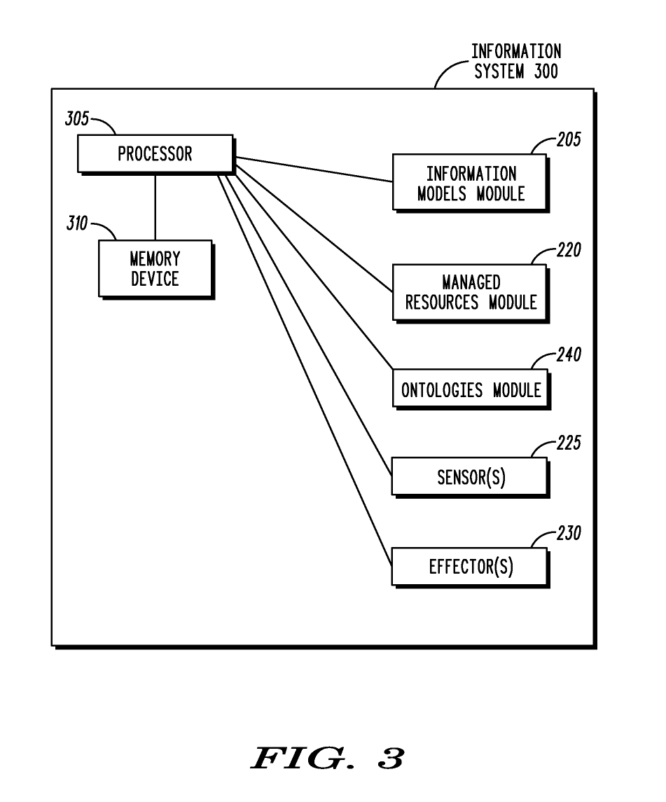

FIG. 1 illustrates a method of defining a new semantic data structure according to at least one illustrative embodiment. First, at operation 100, an event and/or data is accepted from a monitored managed resource. The monitored managed resource may be, e.g. a router or other device. The event and/or data may be detected with sensors implemented, for example, by software executed by a processor within the system. Next, at operation 105, new and existing managed objects are identified that exist in pre-defined information models and ontologies, as described below with respect to FIGS. 2 and 3. At operation 110, objects are analyzed to determine whether additional semantics can be added to them. Finally, at operation 120, a new semantic data structure is defined to hold an integrated combination of original events and/or data and augmented semantic information.

FIG. 2 illustrates an illustrative distributed, but self-contained, subsystem 200. This subsystem 200 enables scalability as well as its modularity. As shown, an information models module 205 communicates information objects to information model mapping logic 210, which coverts the information objects into the Extensible Markup Language (“XML”) format and then communicates the information objects to an object construction bus 215. A managed resources module 220 communicates raw events and/or data (i.e., vendor-specific data) to harmonization logic 235. Sensors 225 may be utilized to detect the raw events and/or data provided by the managed resources module 220. The harmonization logic 235 coverts the raw events and/or data into XML format and then communicates this information to the object construction bus 215 via the semantic model converter 230, which translates vendor-specific information (in XML) to a single normalized form. The harmonization logic 235 may include effectors 230 to convert the single normalized XML format back into vendor-specific commands. An ontologies module 240 communicates knowledge concepts to ontology model mapping logic 245, which converts the knowledge concepts into XML format and then communicates them to the object construction bus 215. The object construction bus 215 communicates all of the information in XML format it has received to the object construction and semantic augmentation logic 250, which adds semantic information to the XML objects it has received and the communicates semantic XML objects to an autonomic processing engine 255.

This arrangement has several advantages. For example, it scales through modularity, i.e., application-specific functionality can be added or removed as needed through adding or removing (or enabling or disabling) different modules that make up the object construction and semantic augmentation logic. This is superior to placing this functionality directly in the autonomic management portion of the system, since by using this placement, the autonomic manager must then have specific knowledge about each and every device that it needs to manage as well as how each device relates to every other device in the system. Hence, this design is similar to the design of the Internet—scalability is achieved by placing application-specific processing functionality at the edge (the harmonization logic 235) instead of in the core (the autonomic processing engine 255).

Another advantage is that it scales through software reuse—the building of a new knowledge processing module can reuse software from existing knowledge processing modules. More importantly, it does not adversely affect other parts of the autonomic system. In other words, these teachings provide for examples that describe a modular subsystem that will announce its capabilities and constraints to the other components of the autonomic system based upon the current set of modules that it contains. At least one embodiment can be implemented using Web Services and a Service-Oriented Architecture.

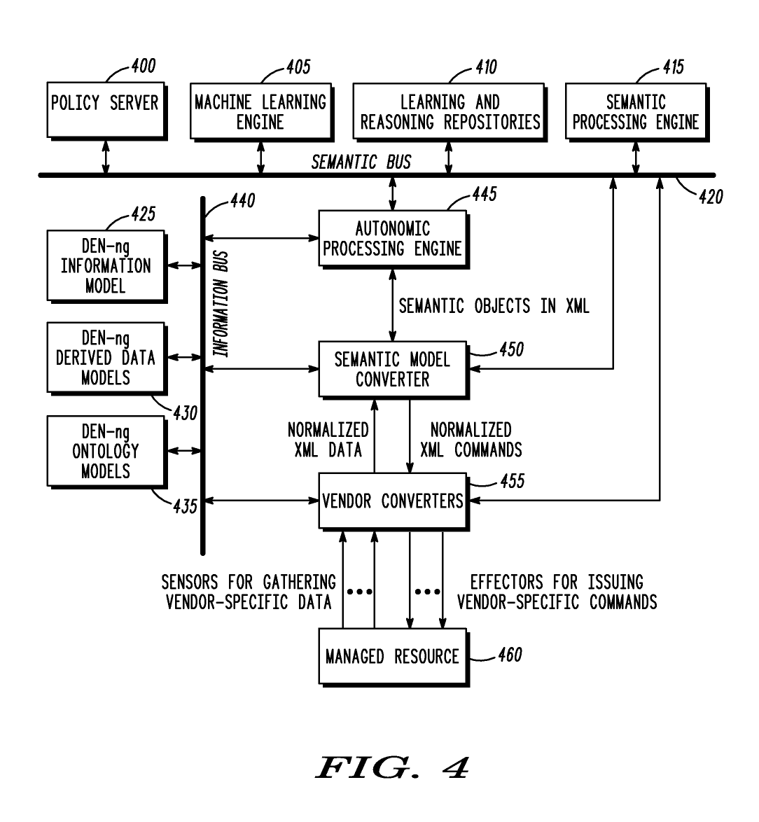

This subsystem 200 also abstracts the specification of semantic information from any specific implementation. It therefore can be used with new and/or legacy devices. It further uses a plurality of approaches to attach semantic meaning to the received events and/or data, as described below with respect to FIGS. 3 and 4. This subsystem uses case-based reasoning using facts defined in an information model to achieve an inherently modular and efficient structure to the semantic augmentation process.

This subsystem 200 also uses case-based reasoning using concepts defined in a set of ontologies to achieve an inherently modular and efficient structure to the semantic augmentation process. It further uses machine learning to avoid costly computational effort by quickly recognizing previous occurrences of received events and/or data and efficiently defining associated augmented semantics. The sub-system 200 also uses knowledge-based reasoning and state awareness to attach semantics to received data and events, thereby reducing the processing required in the autonomic computing management system. It further provides an extensible framework which can accommodate different sets of knowledge on an application-specific basis.

It also enables new data to be dynamically recognized and categorized by using a plurality of information modeling, ontology engineering, machine learning, and knowledge-based reasoning processes. It further uses policy-based management techniques to govern which types of data it is looking for, and what type of semantic information it will use to augment received events and/or data, on a case-by-case basis.

The sub-system 200 also uses machine learning techniques to learn behavior for elements and aggregates of elements to adjust internal representations to semantics, state and events allowable under various states. It further uses machine learning techniques to learn behavior sufficient to assist in predictive or inductive inferencing operations (i.e., inductive hypothesis generation). Moreover, it uses knowledge-based reasoning techniques to alter the gathering of data according to previous data and current hypotheses that are generated (e.g., through abductive hypothesis generation).

FIG. 3 illustrates an information system 300 according to various embodiments of the invention. As shown, the information system 300 includes a processor 305 and a memory device 310. The memory device 310 may include program code/instructions to be executed by the processor 305. Although only one processor 305 and one memory device 310 are shown, it should be appreciated that multiple processors 305 and memory devices 310 may also be utilized. The processor 305 is in communication with the information models module 205, the managed resources module 220, and the ontologies module 240. The processor 305 may also be in communication with sensor(s) 225 and effector(s) 230. By other approaches the sensor(s) 225 and effector(s) 230 may be in direct communication with the managed resources module.

FIG. 4 illustrates a conceptual block diagram of an illustrative autonomic framework based on using the DEN-ng model. As shown, the block diagram includes a policy server 400, a machine learning engine 405, learning and reasoning repositories 410, and a semantic processing engine 415, all of which are in communication with a semantic bus 420. The conceptual block diagram also includes several DEN-ng entities, i.e., a DEN-ng information model 425, DEN-ng derived data models 430, and DEN-ng ontology models 435, all of which are in communication with an information bus 440. An autonomic processing engine 445 is in communication with the semantic bus 420, the information bus 440, and a semantic model converter 450. Vendor converters 455 receive vendor-specific data from a managed resource 460. Sensors (not illustrated) may be utilized, e.g., to gather the vendor-specific data. The vendor converters 455 also transmit vendor-specific commands to the managed resource 460. Effectors (not illustrated) may be utilized to transmit the commands. The vendor converters 455 may transmit normalized XML data to the semantic model converter 450, and may receive normalized XML commands from the semantic model converter 450.

These teachings provide for using the information model to establish facts to compare received sensor data and events against. These facts include characteristics and behavior of entities, along with relationships between different entities and to the environment and users of the system. The DEN-ng model does this as a function of the state of the system and managed resources 460 contained in the system.

Other information and data models may also be used, as long as they have the equivalent functionality of DEN-ng. Otherwise, missing functionality must be accounted for via custom software. Unfortunately, facts in and of themselves are neither sufficient for establishing the meaning of why data was received, nor for establishing what other relationships that are not already defined in the model could exist. Models are also not suitable for identifying contextual changes that occur over time, as well as advanced types of relationships (e.g., “similar to”). Hence, by one approach one augments the data present in the information model with additional data from a set of ontologies. This combination produces a semantic understanding of the significance of the events and/or data received.

The information and ontology models are then used to construct a new semantic data structure that contains facts augmented with different types of semantic information, such as concepts. This semantic data structure contains a set of related knowledge that enables the autonomic processing engine 445 to perform decision-making more effectively.

By at least one approach these teachings describe a set of mechanisms that augment events and data received from a managed resource with additional semantic knowledge from information models as well as from a set of ontologies. Received events and/or data that are normalized into a predefined XML format are accepted, and then managed objects are identified that exist, and the existence of previously unknown managed objects is deduced. These managed objects correspond to objects defined in the information and ontology models contained in these teachings. Once those objects are defined, they are augmented with additional semantic information. The augmentation process is directed by installed policies and/or from an autonomic manager. A new set of semantic objects are constructed that are represented in XML for use by the autonomic system. For example, it enables a system to more quickly determine the relevance of a given event or data, as well as other managed elements that may be affected by the particular event or data received. It also includes facilities to dynamically incorporate new knowledge that can be used to augment future events and data.

The purpose of the construction of semantic objects is twofold. First, it provides more complete meaning for events and data received by the system. This in turn enables static decision-making algorithms predefined in the system to be employed more effectively. Second, it provides the ability to reason about the events and/or data using heuristics. Note that this is different than the current implementation in the art, which simply packages separate data and events into a common event structure and, in particular, does not supply any augmented semantic information. In contrast, this illustrative example has, for all intents and purposes, created a self-describing piece of knowledge—a “knowledge nugget.” Hence, such knowledge nuggets are independent of implementation and domain. These teachings provide for building and maintaining a library of such knowledge nuggets that other components can use. These teachings can be used with essentially any computer system. These illustrative examples are optimized, however, to serve the needs of an autonomic computing system.

Converting all input events and data to a common, normalized form in, e.g., XML enables other components to operate on data in a common, platform-neutral format. Such examples perform two distinct functions: object construction and semantic augmentation, performed by the object construction and semantic augmentation logic 250 shown in FIG. 2. Object construction logic and semantic augmentation logic 250 may be separate entities, or they may be combined as shown in FIG. 2.

The object construction logic 250 accepts input data encoded in XML and, by comparing said input data with known objects in XML form, matches the input data to either a set of managed objects, deduces the existence of a new managed object, or passes the input data on to further processing. The object construction process can be iterative, and may in some cases require multiple passes through the information and ontology mapping logic to construct a set of objects. The further processing uses knowledge-based reasoning techniques to identify the data.

The information and ontology models represent facts and the generalization of facts into concepts, respectively. Since these are necessarily two different ideas, they are stored in separate repositories using different representations. However, both representations (i.e., objects, relationships, and other model constructs) are converted into an equivalent XML form prior to the start of the object construction and semantic augmentation processes. They collectively correspond to a tradeoff between degrees of certainty and uncertainty concerning the received information, as well as the uncertainty that we have in making conclusions about the facts.

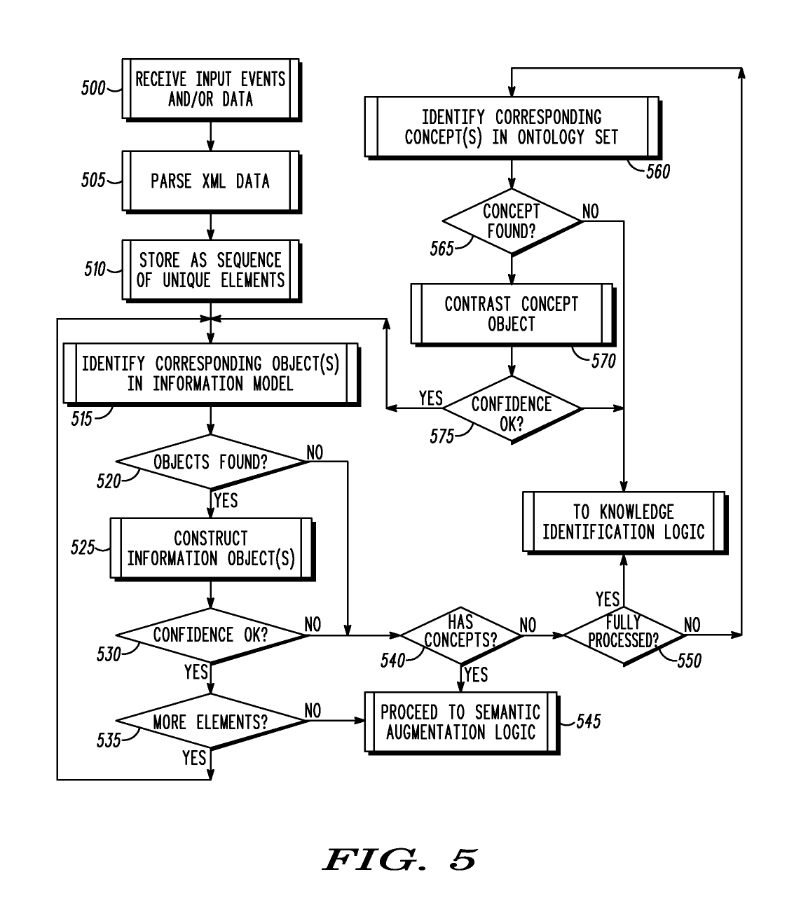

Operation of the object construction process consists of two phases—information object construction and concept construction, as described below with respect to FIG. 5. When constructing information objects, the received XML data is parsed and separated into an ordered sequence of unique elements. Duplicates are encoded in XML, and tagged with the number of duplicates and a set of timestamps. These elements are then stored for further processing.

FIG. 5 illustrates an illustrative object construction process. The initial stage of object construction attempts to match the received events and data received by the semantic model converter 450 of FIG. 4 (now represented as XML elements) to one or more objects in the information model (which are also represented as a set of XML elements). The matching process consists of employing pattern matching techniques to correlate the received data with objects or attributes of an object (the latter of which is in fact the more common case). Techniques such as those used for dictionary lookup, as well as others, can be used. In addition, case-based reasoning may be used, as the indexing function can be thought of as a pattern-matching function. Case-based reasoning may also supply a confidence assignment. First, at operation 500, input events and/or data are received. Next, the XML data is parsed at operation 505, and this is stored as a sequence of unique elements at operation 510. At operation 515, the corresponding objects(s) in the information model are identified. The processing then determines, at operation 520, whether the object is found in the information model. If “yes,” processing proceeds to operation 525. If “no,” processing proceeds to operation 540.

At operation 525, an information object is constructed. Next, a percentage of confidence is assigned to each matched element. This enables the system to reason about the matching process itself, the results of which are used to direct subsequent processing. At operation 530, the processing determines whether the confidence that an object is found to be higher than an adjustable threshold, and then the corresponding set of information model objects are either retrieved or instantiated. If “yes,” processing proceeds to operation 535. If “no,” processing proceeds to operation 540. Each of the attributes of this set of information model objects is marked with data corresponding to the received events (including their frequency of occurrence over a specified time interval (defined by policy) and timestamp).

At operation 535, the processing determines whether there are any more elements to identify. If “yes,” processing returns to operation 515. If “no,” processing proceeds to operation 545. At operation 545, the resulting set of information objects is formulated as a set of information model fragments (more formally, as a set of graphs) and sent to the semantic augmentation processing logic.

The information model objects represent the most basic and concrete facts available in the system. This is why they are mined for first. It is entirely possible, however, that received events and/or data do not directly correspond to objects in the information model. In that case, the identification process is generalized, and at operation 540, the processing searches for concepts (as opposed to predefined, highly structured objects) that match the events and/or data received. This operation can also be invoked if the confidence in matching an existing object in the information model is too low.

There are many reasons to use concepts, especially if the match confidence is too low. Arguably one of the more important is the following: by enabling the autonomic system to operate on knowledge that corresponds as closely as possible to the way that humans think, algorithms can then be built that enable the autonomic system to reason about information in ways similar to how a human thinks.

For example, if an event history is searched for all events that are above a certain threshold, most search systems will return only those events that match this criterion. In contrast, a network technician skilled in the art of network management will also want to know information such as what caused the event, what other managed elements were affected by this event, and what other events were caused by this event. If one were to naively construct such a query, it would either: (1) take a lot of processing time and memory, and/or (2) return mostly useless information. This is because it is very difficult to quantify verbs such as “similar to” and “related to” in many languages. Furthermore, such queries are subject to the quality and structure of the repository (i.e., if the repository was not built expressly for these concepts, then the query will be difficult if not impossible to execute). The problem in network management is that it is in general impossible to anticipate all of the different data and events that will be needed at any given time. It is therefore very difficult to construct an optimal repository.

Additionally, information models derived from UML are limited to relationships that in essence either defines a dependency between objects (e.g., a whole-part) or a subtype (also called “is-a”) relationship. In contrast, ontologies provide a set of rich relationships, such as “is similar to” and “is caused by”. Therefore, these teachings accommodate using both information as well as ontology model matching to identify received events and/or data. A set of ontologies provides concepts as well as relationships between concepts, which provide greater flexibility for the autonomic system to form queries to find the knowledge that it needs.

The allure of the above statements must be balanced by practical processing, storage, and retrieval mechanisms. A goal is to process as small an amount of information as possible. Otherwise, due to the advanced concepts used, the computational processing power (as well as other factors, such as memory) required would soon become intractable.

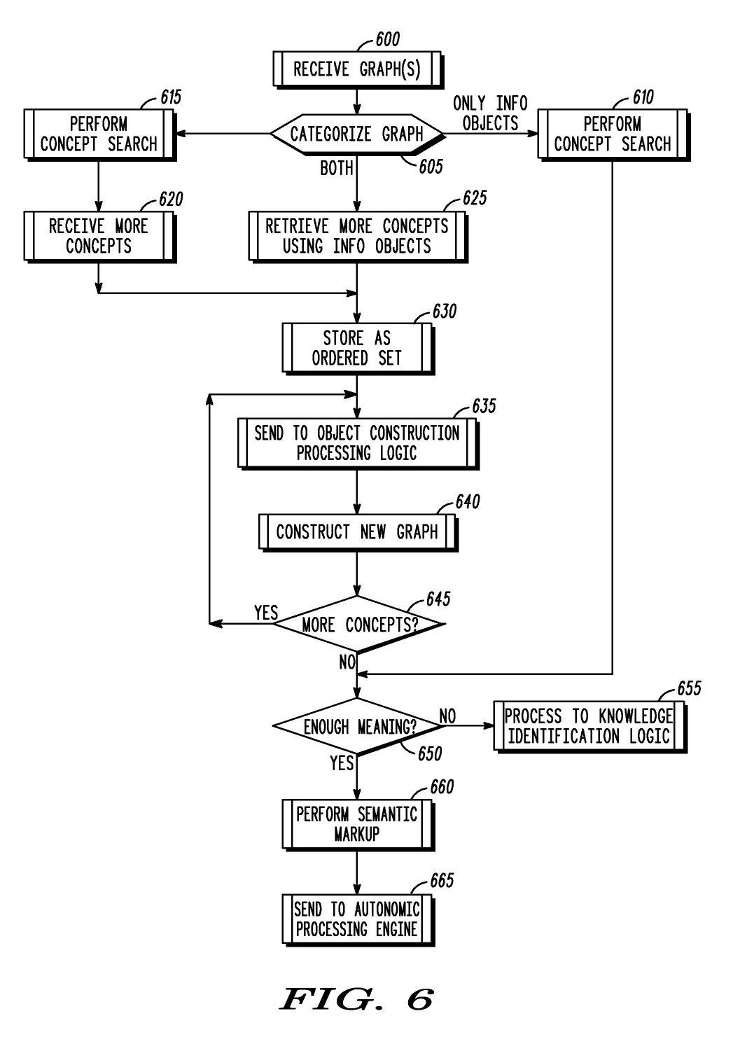

Referring back to FIG. 5, at operation 540, the processing determines whether the information object has concepts. If, at operation 540, the processing determines that there are concepts, processing proceeds to semantic operation logic at operation 545, as discussed below with respect to FIG. 6. If, however, at operation 540 the processing determines that the information object does not have concepts, processing proceeds to operation 550.

In the event that the information model matching operation either failed or did not provide a match with enough confidence, then this process attempts to match the received events and data to one or more concepts in the set of ontology models being used. The matching process consists of employing pattern matching techniques to correlate the received data with concepts defined in the set of ontologies being used. Again, dictionary searches, as well as other suitable mechanisms, can be used for the correlation. The correlation, however, is from specific element to general concept. This illustrative example facilitates this by the construction of information models and ontologies.

Three possible outcomes can occur, i.e., the search will not find any concepts, it will find only concepts and no information objects, or it will only find information objects. In the first case, the received events and/or data will be sent to the knowledge identification logic. In the second case, the set of concept objects will be sent to the semantic augmentation logic. In the third case, both the set of information objects and their associated concept objects will be sent to the semantic augmentation logic.

At operation 550, the processing determines whether the information object has been fully processed. If “yes,” processing proceeds to operation 555. If “no,” processing proceeds to operation 560. At operation 555, processing proceeds to the knowledge identification logic, as discussed below with respect to FIG. 6. The corresponding concepts(s) are identified in the ontology set at operation 560. Next, at operation 565, the processing determines whether the corresponding concept has been found. If “yes,” processing proceeds to operation 570 where a concept object is constructed. If “no,” processing proceeds to operation 555. Finally, at operation 575, the processing determines whether the confidence in the concept object meets a threshold requirement. If “yes,” processing proceeds to operation 515. If “no,” processing proceeds to operation 555.

In the event that a concept is found at operation 565 and a concept object is constructed at operation 570, the next step would be to use the discovered general concept to direct a subsequent set of searches to identify more specific information (i.e., more specific concepts, and ultimately, specific information model objects). This is especially relevant when using ontologies, since they represent structures having a multiplicity of powerful relationships that cannot be represented in an information model. Before each subsequent search in the information model is performed, a percentage of confidence to each matched concept is assigned. This percentage is defined by measuring the semantic similarity between the data element and each applicable concept. The semantic similarity thus performs two functions. First, it enables a matching confidence to be defined, which can be compared with an adjustable threshold. If the confidence is higher than the threshold, then the concept is either retrieved or instantiated. Second, it enables each match to be ordered in terms of most similar to least similar. Thus, instead of having to search all relationships (which could be a very large number), the search can instead start with only those relationships that have the highest similarity.

An illustrative exemplary method to find matching information model objects is described below. First, all concepts that have a semantic similarity value exceeding an adjustable threshold are located. For each concept in the above set, the concept is used as an “index” into the information model to identify a set of information model objects that match the concept. For each matched information model object, their matching is ranked in order as previously described. When a match above an adjustable confidence value is found, the ranking stops. The process is then repeated, lowering the semantic similarity value until an adjustable lower threshold is reached.

Once this process is complete, if there are no more elements to process, the resulting set of information objects (with their associated concept objects) is sent to the semantic augmentation processing logic. It can be important, however, not to simply discard any concept objects that were previously found. Hence, if no information objects are found, a check is made to see if any concepts were found. If concepts were found, then the set of concept objects is sent to the semantic augmentation logic. If neither information nor concept objects were found (which is the primary purpose of the “fully processed” operation 550), then the result is sent to the knowledge identification logic.

If there are more elements to process, then the cycle is repeated. If a concept cannot be found, or if all concepts found are lower than an adjustable threshold, then the knowledge identification logic is invoked. This logic uses knowledge-based reasoning processes to determine the nature of the data, and its results are fed back to the input of this module.

The set of information objects, along with their associated concepts (if any), are then sent to the semantic augmentation logic. The purpose of the semantic augmentation logic is to determine if the set of information objects, with any associated semantic concepts, are specific enough to enable further processing by the autonomic processing engine. The autonomic processing engine defines a granularity of information desired, in terms of objects and concepts, and associated confidence levels for each. Hence, the semantic augmentation logic will attempt to construct graphs of related information, in the form of information and concept objects that can be used by the autonomic processing engine.

Not all data needs semantic augmentation. For example, if the autonomic processing engine is looking for specific data, it most likely does not need anything other than the data itself. On the other hand, if a general event of high relevance (e.g. “link failure”) is received, then it can be very important to add as much additional semantic information as possible (e.g., geographic location, affected customers, and so forth).

If the data does not need semantic augmentation, then the newly constructed objects are matched against the current task being performed. If that task does not need any more data, then the newly constructed objects are sent to the autonomic processing engine. If the current task does need more data, then the semantic augmentation logic will define additional queries to retrieve the data that it needs (based on relationships defined in the information and ontology models), and then issue the appropriate commands to get the required data, which will then be processed by the input harmonization logic.

On the other hand, if the newly constructed objects do need semantic augmentation, then semantic concept similarity matching is performed. This can be done by a variety of algorithms. The semantic augmentation logic is now working, however, with graphs (not nodes).

FIG. 6 illustrates an illustrative semantic augmentation process. The process starts with examining the graph of information objects that were sent by the object construction logic. This can be a graph of information model objects and/or a graph of ontological concept objects. Regardless, the retrieved concept objects will represent the meaning of the graph as a whole. First, at operation 600, the graph(s) are received. Next, at operation 605, a graph is categorized.

Several cases apply based on the categorization of the graph. In the first case, the graph is determined to include only information objects, i.e., no semantics are associated with the objects. The graph is then searched for applicable concepts at operation 610, which will then be added directly to the information objects. Processing proceeds to operation 650, where the semantic augmentation logic determines whether this combination of information and concept objects contains sufficient semantic meaning. This is done by examining the semantic markup compared to the task at hand. If it does, then it is sent to the autonomic processing engine at operation 655. If it does not, processing proceeds to operation 660.

If, at operation 605, the graph is categorized as having only concept objects, i.e., no concrete information objects were found in the object construction process, then processing proceeds to operation 615 where the graph is first searched for other concepts that are both more general and more specific (since the existing concepts did not yield any information objects). The concepts are retrieved at operation 620. Next, at operation 630, the results of this searching are then ordered in terms of their specificity. Next, the concepts are sent to the object construction process at operation 635 (described above with respect to FIG. 5) to once again find information objects. More specific concepts will be used before less specific concepts in this process, because they should provide more direct linkage to information model objects. The results from each search are then constructed into a new graph at operation 640, which is then sent to the semantic augmentation logic for further processing. If it is determined at operation 645 that there are additional concepts, processing returns to operation 635. Otherwise, processing proceeds to operation 650. Note that as soon as a high enough degree of confidence is achieved, the process can stop.

Referring again to operation 605, if the graph is categorized as having both concepts and information objects, processing proceeds to operation 625. A graph of both concepts and information objects means that there is already a semantic relationship associated with information objects, but that more knowledge (in the form of information objects and/or semantics) is needed. This case is the same as the case where the graph contains only concepts, except that the concepts found should be both more general and more specific, since a combination of information objects and semantics are being searched for new concepts at operation 625 and then stored as an ordered set at operation 630. If no concepts are found, then the graph(s) are sent to the knowledge identification logic for further processing at operation 655. The knowledge-based identification logic will attempt to define the nature of the received data and/or events using learning and reasoning techniques. For example, it could analyze the received data and/or events, form a hypothesis as to the cause and effect of the received data and/or events, and then produce a set of queries to test the hypothesis.

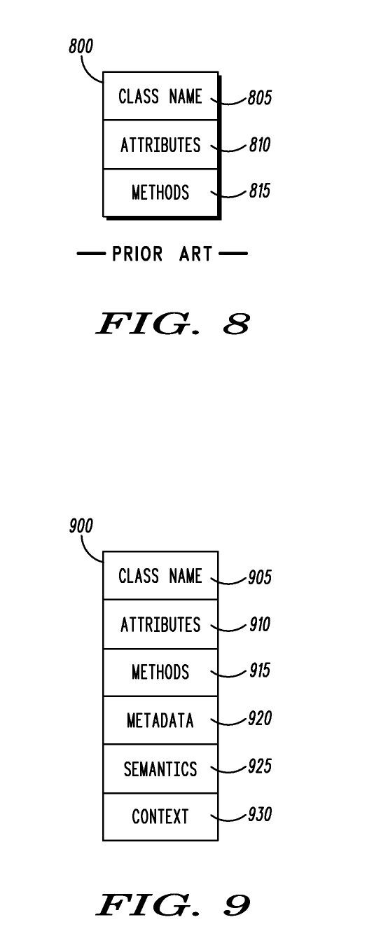

Once all semantic information is gathered, then the set of objects in the graph are marked with semantic information at operation 660 and sent to the autonomic processing engine at operation 665. The semantic marking takes the form of a new data structure. Conceptually this process transforms standard objects as represented in UML (the information model) to semantically augmented objects (adding in ontological information). This is shown in FIGS. 8 and 9 below.

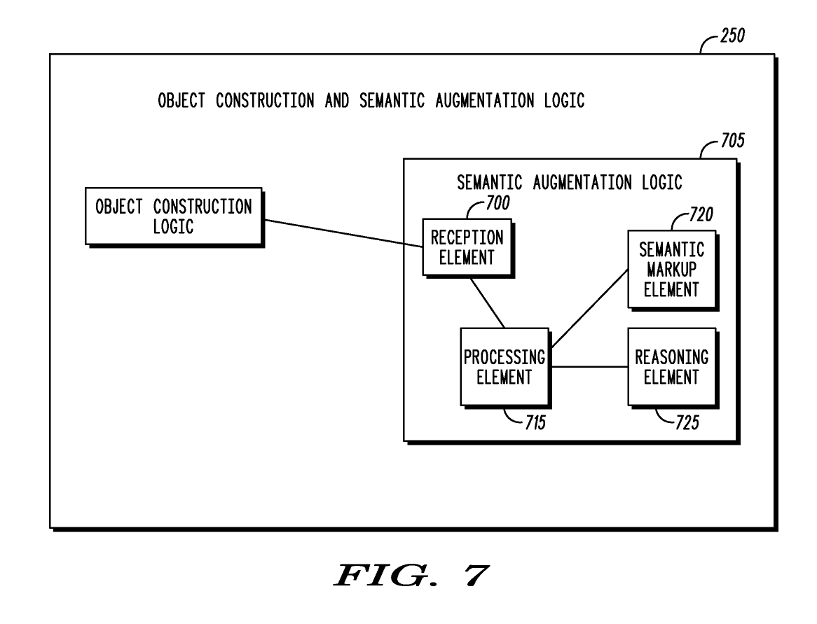

FIG. 7 illustrates an example of the object construction and semantic augmentation logic 250. As shown, the object construction and semantic augmentation logic 250 includes both object construction logic 700 and semantic augmentation logic 705. The semantic augmentation logic 705 includes a reception element 710, a processing element 715, a semantic markup element 720, and a reasoning element 725. The reception element 710 may receive the graph(s) described above at operation 600 of FIG. 6. The processing element 715 may categorize the graph(s), retrieve additional concepts, and store the graph(s) and the additional concepts as a new set. The semantic markup element 720 may perform the semantic markup discussed above at operation 660 of FIG. 6. The reasoning element 725 may reason about events and data through a determination of semantic similarity between the events and data and at least one managed object stored in at least one information model.

FIG. 8 illustrates an object 800 represented in UML according to the prior art, and FIG. 9 illustrates a semantically augmented object 900 that accords with these teachings. As shown, the object 800 includes a class name 805, attributes 810, and methods 815. The semantically augmented object 900, on the other hand, includes a class name 905, attributes 910, methods 915, metadata 920, semantics 925, and context 930.

In general, there is a one-to-many mapping that is enabled by the contextual, situational, and/or conditional adjunct information that already resides in the autonomic processing engine. The semantic markup maps a combination of state, event, and condition data into an object-oriented form that can be efficiently processed in an autonomic control loop.

An important benefit of this process is that this allows for simultaneous evolution of managed element, converter, and autonomic control loop functionality. Metadata 920 and context are, for these purposes, specialized types of semantics 925. Metadata 920 is generated to enable easier semantic processing for future computation. The metadata 920 contains data about data (e.g., the meaning of an encoded format, or timestamp information, or a list of keywords to reference both global concepts as well as other objects that a given object relates to). Context 930 is derived through the semantic similarity matching process. In essence, the similarity matching process identifies objects that relate to each other. Logic then analyzes the resultant set of objects to determine the set of those objects that form the context of the event (e.g., where did the event originate from, why was it sent, and so forth). The context usually refers to a set of objects that the received data applies to.

The final process is to markup the XML objects with semantic information. At this point, the semantic processing logic has transformed normalized XML into semantically augmented XML objects. This enables received as well as to-be-issued data and commands to fill in various grammatical roles in a language that is used to represent policy-based management.

Those skilled in the art will appreciate that these teachings can also be used to discover new information and/or concept objects in the system. The simple case of being able to add new objects is described below.

Consider the case where received events and/or data do not match any objects in the information model. The flow of logic, as described above with respect to FIG. 5, then tries to identify one or more matching concepts in the set of ontologies being used. If a concept is found, then a concept object is constructed, and used as an index to try and find a corresponding object in the information model. If this is successful, then there is a relationship between the original events or data that were received, the original concept, and the newly found information objects. Many times, this can be codified as a new information object (and possibly additional model elements, such as an association) that can be added to the information model. Similarly, new concepts can be defined by examining relationships between newly found objects, as well as by analyzing received events and/or data in response to particular situations encountered by the autonomic processing engine.

There are many advantages provided with respect to these teachings. For example, these teachings offer scale through modularity, i.e., new ontologies, information model elements, data models, and data model elements can be added or removed without affecting the functionality of this subsystem. This is superior to placing this functionality directly in the autonomic management portion of the system, since then the autonomic manager must have specific knowledge about each and every type of information that it needs to manage.

The system also scales through software reuse. That is, the building of new information, data, or ontology objects can reuse software from existing models. More importantly, it does not adversely affect other parts of the autonomic system.

The system further pre-processes information for the autonomic system, providing the autonomic processing element with objects that contain data and their associated semantics. This decreases the complexity of the autonomic manager (note that this adheres to the basic principle of autonomics, which is to define many simple functions to do a complex task instead of a single complex function to do a complex task).

It also abstracts the specification of semantic information from any specific implementation. It can therefore be used with new and/or legacy devices. It uses a plurality of approaches to correlate events and data. It uses a plurality of approaches to identify managed objects and their relation between events, data and concepts. It also uses a plurality of approaches to identify concepts and their relation between managed objects, events and data.

It uses a plurality of approaches to relate information objects and concepts to received events and data, and uses a plurality of approaches to search for information model objects. A plurality of approaches are utilized to search for concept objects and to search for relationships between information model and concept objects.

An efficient and novel semantic data structure is also provided that facilitates knowledge engineering processes by integrating static, behavioral, and semantic knowledge into a single data structure. It uses case-based reasoning using facts defined in an information model to achieve an inherently modular and efficient structure to the semantic augmentation process. It also uses case-based reasoning using facts defined in a set of ontologies to achieve an inherently modular and efficient structure to the semantic augmentation process.

It does not rely on predefined information or even concepts. Instead, it provides the ability to reason about events and data through the determination of semantic similarity of knowledge. It differentiates between a direct match (with 100% probability) that given data corresponds to a particular object or set of objects, and situations with less than 100% probability of a match. This enables a rank-ordered set of probabilities that given data most likely corresponds to a particular object or set of objects.

It also differentiates between a direct match (with 100% probability) that given data corresponds to a particular concept or set of concepts, and situations with less than 100% probability of a match. This enables a rank-ordered set of probabilities that given data most likely corresponds to a particular concept or set of concepts. The ability to provide probability-based matching enables these teachings to identify partial data received by the system.

It further enables new events and data to be dynamically recognized and categorized by using information modeling and ontology engineering. It enables these teachings to hypothesize as to why partial data was received (e.g., did an error occur (such as truncation of transmission) or was there a loss of communication with the managed resource). It also uses policy-based management techniques to govern which types of data it is looking for, and which set of model objects and algorithms it will use.

It defines a software architecture that enables a modular, extensible information representation and application to be realized. It is modular because it defines a set of software objects that can be made up of higher-level modules that can be added or taken away to extend or restrict the overall functionality of the system without impairing its core functionality. It is extensible in that it can be dynamically added to without impairing the functionality of the system.

It uses knowledge-based reasoning and state awareness to attach semantics to received data and events, thereby reducing the processing processes required in the autonomic computing management system. It uses knowledge-based reasoning techniques to alter the gathering of data according to the types of information objects identified in previously collected data and current hypotheses that are generated (e.g. abductive hypothesis generation).

It uses knowledge-based reasoning techniques to alter the gathering of data according to the semantic content of previously collected data and current hypotheses that are generated (e.g., abductive hypothesis generation).

These teachings will accommodate accepting events and/or data received from a monitored managed resource and identifying existing as well as new managed objects that exist in its predefined information models and ontologies. They then analyze these objects for additional semantics that can be added. Such additional semantic information is derived from a multiplicity of information models and/or ontologies. Corresponding approaches then define a new semantic data structure that can hold the integrated combination of the original events and/or data and the augmented semantic information, and are capable of adding newly discovered objects to the information and ontology models dynamically. Accordingly, pursuant to the teachings described above, the addition of semantic data to data and/or events received provides a much more efficient way of handling a monitored managed resource.

These teachings further describe a method comprising receiving at least one of events and data. Object construction logic identifies whether at least one managed object exists in a predefined set of at least one information model and at least one ontology corresponding to the at least one of events and data based on the at least one of events and data. The object construction logic also deduces whether at least one previously unknown managed object exists corresponding to the at least one of events and data based on the at least one of events and data. At least one of the at least one managed object and the at least one previously unknown managed object are augmented with at least one of concept information and semantic information based on knowledge-based reasoning and state awareness, according to at least one installed policy to generate at least one new object. The at least one new object is provide to an autonomic processing engine.

The receiving comprises receiving the at least one of the events and data from a monitored managed resource. New semantic information is enabled to be incorporated into or removed from, the at least one information model and the at least one ontology.

The identifying comprises matching the events and data to the at least one of: (a) at least one managed object in the information model, and (b) at least one concept in the at least one ontology. Such matching is n:m. That is, it includes mapping the reception of n events and/or data to the at least one or more managed objects as well as mapping the reception of one event and/or datum to the at least one or more managed objects. It also includes mapping to the at least one or more concepts as well as mapping the reception of one event and/or datum to the at least one or more concepts. It may also include pre-processing the received events and/or data through various means, such as correlation and/or filtering. The received events and/or data are first processed (e.g., correlation and/or filtering) to produce finer-grained events and/or data to facilitate the mapping process.

The matching comprises employing at least one of: (a) pattern matching techniques to match the at least one of events and data with at least one of (i) the least one managed object and the at least one previously unknown managed object, and (ii) at least one attribute of the at least one managed object and the at least one previously unknown managed object; and (b) at least one semantic technique to match at least one of: (i) content of the at least one of events and data with at least one of the least one managed object and the at least one previously unknown managed object, (ii) a meaning of the at least one of events and data with at least one of concepts in the at least one ontology, the least one managed object, and the at least one previously unknown managed object; and (iii) a definition of the at least one of events and data with at least one of the concepts in the at least one ontology.

The augmenting may comprise receiving at least one of a graph of information objects and ontological concept objects from the object construction logic. The augmenting may also comprise categorizing the graph, retrieving additional concepts, and storing the graph and the additional concepts as at least one new graph. The augmenting may further comprise sending the at least one new graph to the object construction logic for additional processing, constructing at least one new graph, and determining whether any additional corresponding concepts exist. In response to determining that no additional corresponding concepts exist and sufficient meaning is present in the at least one new graph, a semantic markup is performed to the new graph.

The teachings discussed herein also describe a system having object construction logic and semantic augmentation logic. The object construction logic is used to (a) receive at least one of events and data, (b) identify, based on the at least one of events and data, whether managed objects exist in a predefined set of at least one information model and at least one ontology corresponding to the at least one of events and data, and (c) deduce, based on the at least one of events and data, whether any previously unknown managed objects exist corresponding to the at least one of events and data. The semantic augmentation logic is utilized to augment at least one of the managed objects and the previously unknown managed object with at least one of concept information and semantic information based on knowledge-based reasoning and state awareness, according to at least one installed policy to generate at least one new object and provide the at least one new object to an autonomic processing engine.

The semantic augmentation logic may include a reception element to receive at least one of a graph of information objects and ontological concept objects from the object construction logic. The semantic augmentation logic may comprise a processing element to categorize the at least one graph, retrieve additional concepts, and store the graph and the additional concepts as at least one new graph. The processing element is adapted to send the at least one new graph to the object construction logic for additional processing, construct at least one additional new graph, and determine whether any additional corresponding concepts exist. The semantic augmentation logic may also include a semantic markup element to perform a semantic markup to the at least one additional new graph in response to determining that no additional corresponding concepts exist and sufficient meaning is present in the new graph.

The teachings discussed herein also describe semantic augmentation logic having a reception element and a processing element. The reception element receives, from an object construction logic, at least one of: (a) managed objects existing in a predefined set of at least one information model and at least one ontology corresponding to at least one of events and data received from a monitored managed resource, and (b) previously unknown managed objects existing corresponding to the at least one of events and data. The processing element augments at least one of the managed objects and the previously unknown managed object with at least one of concept information and semantic information based on knowledge-based reasoning and state awareness, according to at least one installed policy to generate at least one new object and provides the at least one new object to an autonomic processing engine.

The semantic augmentation logic may also include a reception element to receive at least one of a graph of information objects and ontological concept objects from the object construction logic. A processing element may be utilized to categorize the at least one graph, retrieve additional concepts, and store the graph and the additional concepts as a new set. The processing element is adapted to send the new set to the object construction logic for additional processing, construct a new graph, and determine whether any additional corresponding concepts exist.

A semantic markup element to perform a semantic markup to the new graph in response to determining that no additional corresponding concepts exist and sufficient meaning is present in the new graph. A reasoning element to reason about events and data through a determination of semantic similarity between the events and data and at least one managed object stored in the at least one information model. The semantic augmentation logic can also reason about events and data through the determination of semantic similarity between the events and data and at least one concept stored in the at least one ontology.

The semantic augmentation logic can differentiate between a direct match (with 100% probability) that given event and data corresponds to a particular object or set of objects, and situations with less than 100% probability of a match. A rank-ordered set of probabilities is utilized that given a event and data most likely corresponds to a particular object or set of objects is produced.

The semantic augmentation logic differentiates between a direct match (with 100% probability) that given data corresponds to a particular concept or set of concepts, and situations with less than 100% probability of a match. Also, another rank-ordered set of probabilities may be utilized that the given data most likely corresponds to a particular concept or set of concepts is produced. The semantic augmentation logic may further provide a probability-based matching algorithms facilitating the identification of partial data and event received by the system.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the current inventive concept.

We claim:

1. A method comprising:
receiving at least one of events and data;
identifying, by object construction logic based on the at least one of events and data, whether at least one managed object exists in a predefined set of at least one information model and at least one ontology corresponding to the at least one of events and data;
deducing, by the object construction logic based on the at least one of events and data, whether at least one previously unknown managed object exists corresponding to the at least one of events and data; and
augmenting at least one of the at least one managed object and the at least one previously unknown managed object with at least one of concept information and semantic information based on knowledge-based reasoning and state awareness, according to at least one installed policy to generate at least one new object; and
providing the at least one new object to an autonomic processing engine.

2. The method of claim 1, the receiving comprising receiving the at least one of events and data from a monitored managed resource.

3. The method of claim 1, further comprising enabling new semantic information to be at least one of incorporated into and removed from, the at least one information model and the at least one ontology.

4. The method of claim 1, the identifying comprising matching the at least one of events and data to at least one of:
at least one managed object in the information model, and
at least one concept in the at least one ontology.

5. The method of claim 4, the matching comprising employing at least one of:
pattern matching techniques to match the at least one of events and data with at least one of
the at least one managed object and the at least one previously unknown managed object, and
at least one attribute of the at least one managed object and the at least one previously unknown managed object; and
at least one semantic technique to match at least one of:
content of the at least one of events and data with at least one of the at least one managed object and the at least one previously unknown managed object;
a meaning of the at least one of events and data with at least one of: a concept in the at least one ontology, the at least one managed object, and the at least one previously unknown managed object; and
a definition of the at least one of events and data with at least one concept in the at least one ontology.

6. The method of claim 1, the augmenting comprising receiving at least one of a graph of information objects and ontological concept objects from the object construction logic.

7. The method of claim 6, the augmenting comprising categorizing the graph, retrieving additional concepts, and storing the graph and the additional concepts as at least one new graph.

8. The method of claim 7, the augmenting further comprising sending the at least one new graph to the object construction logic for additional processing, constructing at least one additional new graph, and determining whether any additional corresponding concepts exist.

9. The method of claim 8, wherein in response to determining that no additional corresponding concepts exist and sufficient meaning is present in the at least one new graph, performing a semantic markup to the new graph.

10. A system, comprising:
object construction logic to:
receive at least one of events and data,
identify, based on the at least one of events and data, whether managed objects exist in a predefined set of at least one information model and at least one ontology corresponding to the at least one of events and data, and
deduce, based on the at least one of events and data, whether any previously unknown managed objects exist corresponding to the at least one of events and data; and
semantic augmentation logic to augment at least one of the managed objects and the previously unknown managed object with at least one of concept information and semantic information based on knowledge-based reasoning and state awareness, according to at least one installed policy to generate at least one new object and provide the at least one new object to an autonomic processing engine.

11. The system of claim 10, the semantic augmentation logic having a reception element to receive at least one of a graph of information objects and ontological concept objects from the object construction logic.

12. The system of claim 11, the semantic augmentation logic comprising a processing element to categorize the at least one graph, retrieve additional concepts, and store the graph and the additional concepts as at least one new graph.

13. The system of claim 12, the processing element being adapted to send the at least one new graph to the object construction logic for additional processing, construct at least one additional new graph, and determine whether any additional corresponding concepts exist.

14. The system of claim 13, the semantic augmentation logic comprising a semantic markup element to perform a semantic markup to the at least one additional new graph in response to determining that no additional corresponding concepts exist and sufficient meaning is present in the new graph.

15. Semantic augmentation logic, comprising:
a reception element to receive, from an object construction logic, at least one of:
managed objects existing in a predefined set of at least one information model and at least one ontology corresponding to at least one of events and data received from a monitored managed resource, and
previously unknown managed objects existing corresponding to the at least one of events and data; and
a processing element to augment at least one of the managed objects and the previously unknown managed objects with at least one of concept information and semantic information based on knowledge-based reasoning and state awareness, according to at least one installed policy to generate at least one new object and provide the at least one new object to an autonomic processing engine.

16. The semantic augmentation logic of claim 15, the semantic augmentation logic further having a reception element to receive at least one of a graph of information objects and ontological concept objects from the object construction logic.

17. The semantic augmentation logic of claim 16, the semantic augmentation logic comprising a processing element to categorize the at least one graph, retrieve additional concepts, and store the graph and the additional concepts as a new set.

18. The semantic augmentation logic of claim 17, the processing element being adapted to send the new set to the object construction logic for additional processing, construct a new graph, and determine whether any additional corresponding concepts exist.

19. The semantic augmentation logic of claim 18, further comprising a semantic markup element to perform a semantic markup to the new graph in response to determining that no additional corresponding concepts exist and sufficient meaning is present in the new graph.

20. The semantic augmentation logic of claim 18, further comprising a reasoning element to reason about events and data through a determination of semantic similarity between the at least one of events and data and at least one managed object stored in the at least one information model.
